(19) United States
(12) Patent Application Publication
(10) Pub. No.: US 2006/0020980 A1
(43) Pub. Date: Jan. 26, 2006

(54) Wireless digital audio and video transmission device

(76) Inventor: Juen Tien Peng, Chung Li (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/894,003

(22) Filed: Jul. 20, 2004

(51) Int. Cl. H04N 7/18; H04N 7/173

(52) U.S. Cl. 725/81; 725/100; 725/131; 725/80

(57) ABSTRACT

A wireless digital audio and video transmission device includes a multimedia video device employed as an AV signal generator, and at least one display device. The multimedia video device includes a wireless transmission module, a video compression module, a lock code module and an antenna device. The wireless transmission module includes a wireless emitter and a wireless receiver. The antenna device is communicated to the wireless receiver and the wireless emitter. Each display device includes a wireless transmission module and a display. The wireless transmission module includes a wireless emitter and a wireless receiver.

### BACKGROUND OF THE INVENTION

1. Field of the Invention

The present invention relates to an audio and video (AV) transmission device, and particularly to a wireless digital audio and video transmission device which wirelessly transmits AV signals from a multimedia video device thereof to a display thereof.

2. Prior Art

As development of technology, various multimedia video devices, such as a DVD player, a cable TV and a satellite TV, are widely applied in modern life. However, each conventional multimedia video device is a separated system through wire connection, which results that the multimedia video device can only be used in a limited space. For example, when a person leaves a room in which he watches TV, he cannot go on watching TV. Therefore, it is inconvenient to use the multimedia video device.

Furthermore, when a user does not take with a conventional multimedia video device, he cannot watch a program through the multimedia video device. In other words, when a user leaves a conventional multimedia video device, he cannot use it. Therefore, use of the conventional multimedia video device is limited by space and so is inconvenient.

### SUMMARY OF THE INVENTION

Accordingly, an object of the present invention is to provide a wireless digital audio and video transmission device, which includes a wireless emitter connected to a multimedia video device employed as an AV signal generator and a wireless receiver connected to a display device for receiving signals from the wireless emitter, whereby it is ready to display the signals from the AV signal generator and so it is convenient to watch a program without limitation of space.

Another object of the present invention is to provide a wireless digital audio and video transmission device, which includes a wireless receiver connected to a display device for displaying the received signals and a remote controller for selection of programs and tuning of volume whereby it is convenient to use a multimedia video device of the wireless digital audio and video transmission device without limitation of space.

Another object of the present invention is to provide a wireless digital audio and video transmission device, which connects a multimedia video device employed as an AV signal generator to a plurality of display devices through wireless AV signal transmission, whereby it is convenient to keep watching program without limitation of space.

To achieve the above-mentioned objects, a wireless digital audio and video transmission device in accordance with the present invention includes a multimedia video device employed as an AV signal generator, and at least one display device. The multimedia video device includes a wireless transmission module, a video compression module, a lock code module and an antenna device. The wireless transmission module includes a wireless emitter and a wireless receiver. The antenna device is communicated to the wireless receiver and the wireless emitter. Each display device includes a wireless transmission module and a display. The wireless transmission module includes a wireless emitter and a wireless receiver.

Other objects, advantages and novel features of the present invention will be drawn from the following detailed embodiment of the present invention with attached drawings, in which:

### BRIEF DESCRIPTION OF THE DRAWINGS

FIG. 1 is a schematic view of a wireless digital audio and video transmission device of the present invention; and

FIG. 2 is a flow chart showing signal transmission of the wireless digital audio and video transmission device of the present invention.

### DESCRIPTION OF THE PREFERRED EMBODIMENT

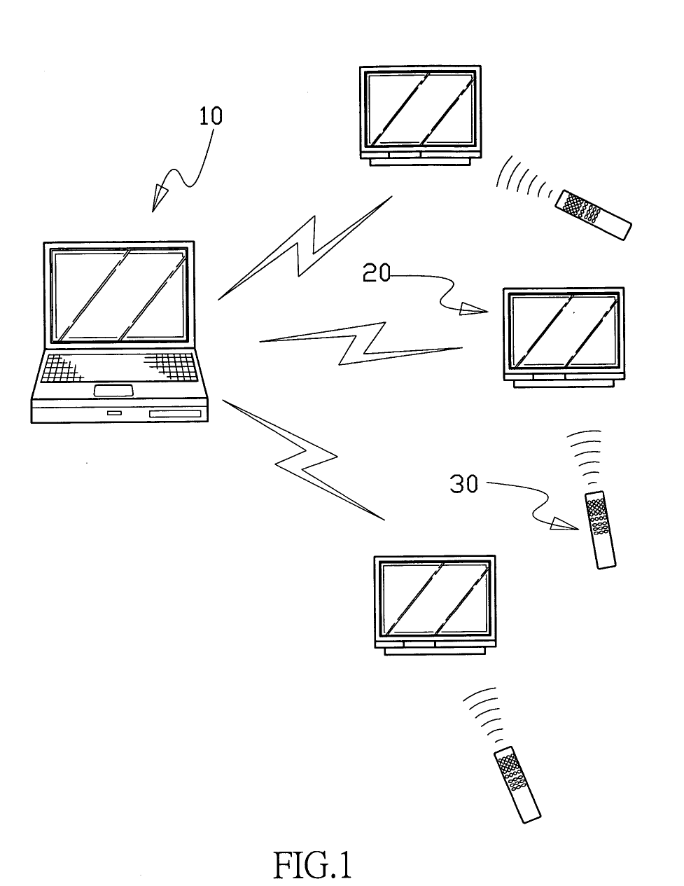

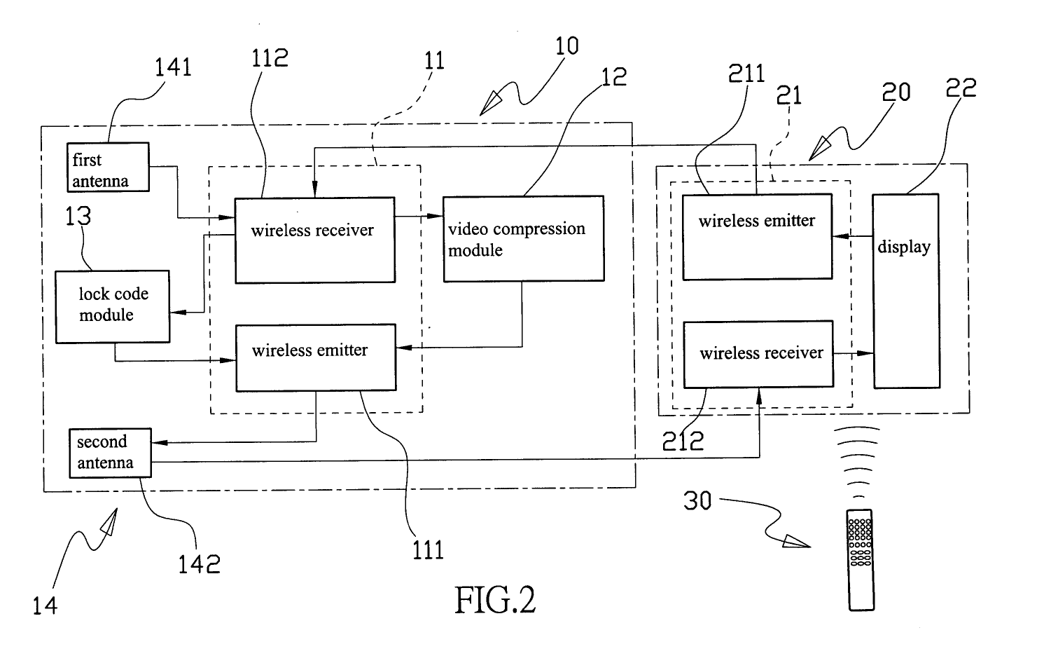

Referring to FIGS. 1-2, a wireless digital audio and video transmission device of the present invention includes a multimedia video device 10 and a plurality of display devices 20. The multimedia video device 10 is employed as an audio and video (AV) signal generator, such as a DVD player, a cable TV, a satellite TV and a computer. The multimedia video device 10 includes a wireless transmission module 11, a video compression module 12, a lock code module 13 and an antenna device 14. The wireless transmission module 11 may transmit signals through Bluetooth or Infrared Data Association (IrDA). The wireless transmission module 11 includes a wireless emitter 111 and a wireless receiver 112. The video compression module 12 is employed to compress AV data to be in other format such as MPEG for facilitating to play and transmit. The lock code module 13 is configured with a lock code for verifying a received lock code signal and then deciding if the subsequential received signals access a controlling process. The antenna device 14 includes a first antenna 141 and a second antenna 142. The first antenna 141 is communicated to the wireless receiver 112. The second antenna 142 is communicated to the wireless emitter 111.

The display device 20 includes a wireless transmission module 21 and a display 22. The wireless transmission module 21 may transmit signals through Bluetooth or IrDA. The wireless transmission module 21 includes a wireless emitter 211 and a wireless receiver 212. The display 22 is an LCD.

In this embodiment, the multimedia video device 10 is a computer which can be used to visit internet and receive or send emails. The multimedia video device 10 includes four AV contacts AV1, AV2, AV3 and AV4 for transmitting signals of a DVD, a TV, a SAT and so on. The wireless transmission modules 11, 21 transmit digital signals through 802.11a for high quality of digital signal transmission.

As shown in FIG. 2, the wireless receiver 112 of the multimedia video device 10 receives AV signals from the first antenna 141. Then the AV signals are compressed by the video compression module 12 and then are transmitted to the wireless emitter 111 and emitted by the second antenna 142. The wireless receiver 212 of the display device 20 receives the AV signals emitted by the second antenna 142 through wireless transmission and then transmits the AV signals to the display 22 for display.

Furthermore, the display 22 may be controlled by a remote controller 30. That's, a password signal is input through the remote controller 30 and then emitted by the wireless emitter 211 of the display device 20. The wireless receiver 112 of the multimedia video device 10 receives the password signal and then transmits the password signal to the lock code module 13. When the password signal is verified, controlling signals are transmitted to the wireless receiver 212 and the display 22 of the display device 20 through the wireless emitter 111 and the second antenna 142. Thus, the remote controller 30 can be used for selection of programs and tuning of volume whereby it is convenient to use a multimedia video device of the wireless digital audio and video transmission device without limitation of space.

As mentioned above, the wireless digital audio and video transmission device of the present invention provides the wireless transmission device to connect to the AV signal generator, and transmits AV signals to the wireless receiver of the display device through 802.11a for displaying the AV signals. Furthermore, a user can select a program and tune volume through the remote controller. It is convenient to use without limitation of space due to wireless transmission.

It is understood that the invention may be embodied in other forms without departing from the spirit thereof. Thus, the present examples and embodiments are to be considered in all respects as illustrative and not restrictive, and the invention is not to be limited to the details given herein.

1. A wireless digital audio and video transmission device, comprising:
a multimedia video device, employed as an AV signal generator, the multimedia video device comprising a wireless transmission module, a video compression module, a lock code module and an antenna device, the wireless transmission module comprising a wireless emitter and a wireless receiver, the antenna device being communicated to the wireless receiver and the wireless emitter; and
at least one display device, each display device comprising a wireless transmission module and a display, the wireless transmission module comprising a wireless emitter and a wireless receiver.

2. The wireless digital audio and video transmission device as claimed in claim 1, wherein the multimedia video device is a DVD player, a cable TV, a satellite TV or a computer.

3. The wireless digital audio and video transmission device as claimed in claim 1, wherein the wireless transmission module of the multimedia video device transmits signals though Bluetooth.

4. The wireless digital audio and video transmission device as claimed in claim 1, wherein the wireless transmission module of the multimedia video device transmits signals through Infrared Data Association (IrDA).

5. The wireless digital audio and video transmission device as claimed in claim 1, wherein the video compression module is employed to compress AV data to be in MPEG format.

6. The wireless digital audio and video transmission device as claimed in claim 1, wherein the lock code module is configured with a lock code and is employed to verify a received lock code signal with the lock code.

7. The wireless digital audio and video transmission device as claimed in claim 1, wherein the wireless transmission module of the display device transmits signals though Bluetooth.

8. The wireless digital audio and video transmission device as claimed in claim 1, wherein the wireless transmission module of the display device transmits signals through IrDA.

9. The wireless digital audio and video transmission device as claimed in claim 1, wherein the display is an LCD.

10. The wireless digital audio and video transmission device as claimed in claim 1, wherein the multimedia video device includes four AV contacts AV1, AV2, AV3 and AV4.

11. The wireless digital audio and video transmission device as claimed in claim 1, wherein the wireless transmission module of the multimedia video device transmits digital signals through 802.11a.

12. The wireless digital audio and video transmission device as claimed in claim 1, wherein the wireless transmission module of the display device transmits digital signals through 802.11a.

13. The wireless digital audio and video transmission device as claimed in claim 1, wherein the display is controlled by verifying a password signal input through a remote controller.
